(19) United States
(12) Patent Application Publication
(10) Pub. No.: US 2012/0186535 A1
(43) Pub. Date: Jul. 26, 2012

(54) Bone shaped pet product

(76) Inventor: Hua Tu, Changhua (TW)

(21) Appl. No.: 12/931,227

(22) Filed: Jan. 26, 2011

(51) Int. Cl. A01K 29/00

(52) U.S. Cl. 119/710

(57) ABSTRACT

A bone shaped pet product includes a longitudinal food member and a longitudinal rope member tied together to form two knots and to form a bone shaped structure, the longitudinal food member is made of cattle hide material or other food materials, and the longitudinal rope member is made of fiber materials, such as cotton fibers and includes two or more strands of fiber or thread materials. The longitudinal food member and the longitudinal rope member may be twisted together to form a further solid and stable structure.

### BACKGROUND OF THE INVENTION

1. Field of the Invention

The present invention relates to a bone shaped pet product, and more particularly to a bone shaped pet product including an improved structure for forming a solid and stable structure and for preventing the pet product from being easily and quickly bitten by the pet and for increasing the working life of the pet.

2. Description of the Prior Art

Typical bone shaped pet products comprise a bone shaped body made of food materials, such as herb materials, natural bone meal materials, meat materials, cattle hide materials, or other food materials, for providing food to the pet or for teeth cleaning purposes for the pet.

For example, U.S. Design Pat. No. US D453,980 to Shoemaker et al., and U.S. Design Pat. No. US D475,816 to Adamson disclose two of the typical bone shaped pet products and each also comprising a bone shaped body made of various kinds of food materials.

However, the bone shaped body which is made of food materials includes a relatively weak structure that will be easily and quickly bitten and eaten by the pet and that includes a relatively shorter working life and that may not be used for suitably cleaning the teeth of the pet.

The present invention has arisen to mitigate and/or obviate the afore-described disadvantages of the conventional bone shaped pet products.

### SUMMARY OF THE INVENTION

The primary objective of the present invention is to provide a bone shaped pet product including an improved structure for forming a solid and stable structure and for preventing the pet product from being easily and quickly bitten by the pet and for increasing the working life of the pet.

In accordance with one aspect of the invention, there is provided a bone shaped pet product comprising a longitudinal food member, and a longitudinal rope member, the longitudinal food member and the longitudinal rope member being tied together to form two knots and to form a bone shaped structure.

The longitudinal food member and the longitudinal rope member may be twisted together to form a further solid and stable structure.

The longitudinal food member may be made of herb materials, natural bone meal materials, meat materials, cattle hide materials, or other food materials.

The longitudinal rope member may be made of fiber materials, such as selected from a cotton fibers, and may include two or more strands of fiber or thread materials.

The longitudinal food member and said longitudinal rope member each include two ends extended out of said knots respectively.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a bone shaped pet product in accordance with the present invention.

### DETAILED DESCRIPTION OF THE PREFERRED EMBODIMENT

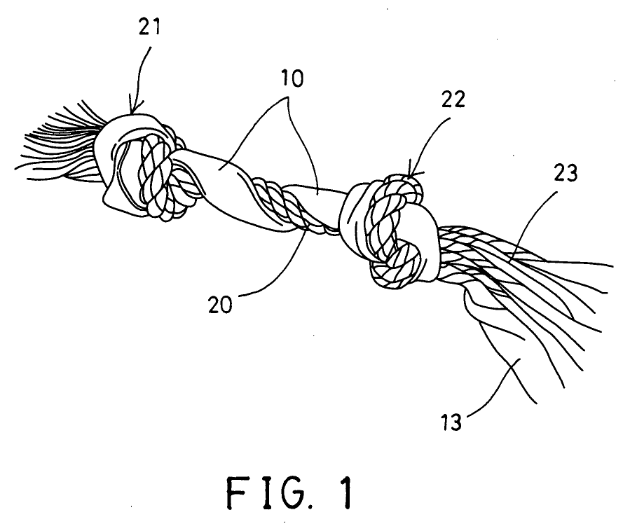

Referring to the drawing FIG. 1, a bone shaped pet product in accordance with the present invention comprises a longitudinal food member 10 made of food materials, such as herb materials, natural bone meal materials, meat materials, cattle hide materials, or other food materials, and particularly made of the cattle hide materials, and a longitudinal wire or string or cord or rope member 20 made of fiber or thread materials, such as cotton fibers or the like, and having two or more strands of the fiber or thread materials.

The longitudinal food member 10 and the longitudinal rope member 20 are then twisted and/or tied together to form two knots 21, 22 each having both the longitudinal food member 10 and the longitudinal rope member 20 tied and entangled together to form a bone shaped product, and the longitudinal food member 10 and the longitudinal rope member 20 each include two ends 13, 23 extended out of the knots 21, 22 respectively.

It is to be noted that the food member 10 may be bitten and eaten by the pet and, but the rope member 20 may not be easily and quickly bitten by the pet, such that the bone shaped pet product includes a solid and stable structure that may not be easily and quickly bitten and eaten by the pet and includes an increased working life for such as teeth cleaning purposes.

Accordingly, the bone shaped pet product in accordance with the present invention includes an improved structure for forming a solid and stable structure and for preventing the pet product from being easily and quickly bitten by the pet and for increasing the working life of the pet product.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A bone shaped pet product comprising:
a longitudinal food member, and
a longitudinal rope member, said longitudinal food member and said longitudinal rope member being tied together to form two knots and to form a bone shaped structure.

2. The bone shaped pet product as claimed in claim 1, wherein said longitudinal food member and said longitudinal rope member are twisted together.

3. The bone shaped pet product as claimed in claim 1, wherein said longitudinal food member is made of a cattle hide material.

4. The bone shaped pet product as claimed in claim 1, wherein said longitudinal rope member is made of a fiber material.

5. The bone shaped pet product as claimed in claim 4, wherein said fiber material is selected from a cotton fiber.

6. The bone shaped pet product as claimed in claim 1, wherein said longitudinal rope member includes at least two strands of thread materials.

7. The bone shaped pet product as claimed in claim 1, wherein said longitudinal food member and said longitudinal rope member each include two ends extended out of said knots respectively.
